(19) United States
(12) Patent Application Publication
(10) Pub. No.: US 2017/0116691 A1
(43) Pub. Date: Apr. 27, 2017

(54) Network Enabled System and Method for Transacting Property Sales and Rentals without a Real Estate Agent

(71) Applicant: Tin-Jon Syiau, Arcadia, CA (US)

(72) Inventor: Tin-Jon Syiau, Arcadia, CA (US)

(21) Appl. No.: 15/331,884

(22) Filed: Oct. 23, 2016

Related U.S. Application Data
(60) Provisional application No. 62/245,934, filed on Oct. 23, 2015.

(51) Int. Cl. G06Q 50/16; G06Q 30/06; H04L 29/06; G06Q 50/00

(52) U.S. Cl. CPC G06Q 50/167; G06Q 50/01; G06Q 30/0645; H04L 63/10

(57) ABSTRACT

A network enabled system and method for transacting property sales and rentals without a real estate agent. The method provides a network, accessible to a property seller, a buyer, a landlord, and a renter. The network facilitates a property transaction for property between the buyer and the seller, such that a real estate agent is not required. The system matches a seller of a real estate property with a potential buyer through the network. The seller can display the property on the network. The system allows the buyer to indicate desired property criteria. The seller and buyer review each other personal information, property records, and property criteria to determine if the property is appropriate for buyer. The seller and the buyer communicate directly and in real time on the network. This open communication negates the need to use the agent. The method also provides directions that facilitate the transaction.

### CROSS REFERENCE OF RELATED APPLICATIONS

This application claims the benefits of U.S. provisional application No. 62245934, filed Oct. 23, 2015, and entitled SYSTEM AND METHOD FOR DIRECT MATCHING OF SELLER AND BUYER OR LANDLORD AND RENTER FOR A REAL ESTATE TRANSACTION WITHOUT REQUIRING AN AGENT, which provisional application is incorporated by reference herein in its entirety.

### FIELD OF THE INVENTION

The present invention relates generally to a network enabled system and method for transacting property sales and rentals without a real estate agent. More so, a system and method provides a network, which is accessible to a real estate property seller and a potential buyer, or a landlord and a potential renter, that facilitates the procedures for a direct real estate transaction between the buyer and the seller, such that a real estate agent is not required; whereby the seller lists a property on the network, provides information about the property, determines a purchase price for the property, provides a seller identification, and opens the property for visits; whereby the buyer: determines criteria for a desired property, lists the property criteria on a network, provides buyer identification, visits the listed property, and makes an offer for the listed property; whereby the buyer and seller are in constant communication through the network; whereby the system and method provides direction for performing various transaction coordination functions.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, real estate includes property consisting of land and the buildings on it, along with its natural resources such as crops, minerals or water. The business of transacting real estate involves buying, selling, or renting land, buildings or housing. A real estate agent may bed to act as an intermediary between sellers and buyers of real estate property and attempts to find sellers who wish to sell and buyers who wish to buy. The agent is usually compensated with a commission. A typical sales commission is 6% (3% for the seller and 3% for the buyer).

In many instances, selling real property to a buyer is usually facilitated by a Real Estate Agent (REA). A REA representing the seller provides services such as placing a description of the property in a multiple listing service (MLS), advertising the property, showing a house during an open house, receiving offers from the buyer's REA, presenting offers to the seller, providing advice to the sellers, representing the sellers in negotiations with buyers, arranging other service providers such as Title Company, Escrow company, inspections, etc.

Often, a buyer's REA filters the houses on the MLS or other source of property advertisements according to the criteria provider by the buyers, takes the buyers on tours of the properties meeting the criteria, writes offers, and represents the buyers in negotiations regarding the purchase agreement with the seller's REA. The REA's are compensated for their service by a commission on the sale of the property.

However, there are also disadvantages of working with a REA. When dealing with expensive real estate prices, the commission represents a significant amount of money. Another disadvantage is that there may be a conflict of interest between the REA and the represented party. An REA's motivation is to make a quick sale, earn their commission, and move on. A quick and easy sale is not necessarily one that will bring in the highest price for a seller or the lowest price for a buyer.

Other proposals have involved facilitating real estate transactions. The problem with these is that they require a real estate agent and do not provide a network for facilitating the transaction. Even though the above cited real estate methods meet some of the needs of the market, a network enabled system and method for transacting property sales and rentals without a real estate agent which is accessible to a real estate property seller and a potential buyer, or a landlord and a potential renter; whereby the seller lists a property on the network, provides information about the property, determines a purchase price for the property, provides a seller identification, and opens the property for visits; and whereby the buyer: determines criteria for a desired property, lists the property criteria on a network, provides buyer identification, visits the listed property, and makes an offer for the listed property; and whereby the buyer and seller are in constant communication through the network; and whereby the direction for performing the transaction are provided is still desired.

### SUMMARY

The Illustrative embodiments of the disclosure are generally directed to a network enabled system and method for transacting property sales and rentals without a real estate agent. The system and method is configured to provide a network for sellers, buyers, landlords, and potential renters of a property to communicate for transacting a property. The system and method enables the seller, buyer, landlord, and renter to enter into a contract and transfer property safely without relying on or paying commission to a real estate agent or broker. A network enables the buyer and seller to communicate in real time. The buyer and seller not only display the property for sale and the desired property criteria, but also provide property records and personal information to increase the veracity of the transaction.

In some embodiments, the system and method provides a network, which is accessible to a real estate property seller and a potential buyer that facilitates a direct real estate transaction for at least one property between the buyer and the seller, such that a real estate agent is not required. The system matches a seller of a real estate property with a potential buyer through the network. The system allows the seller to display the property on the network. The system also allows the buyer to indicate desired property criteria. The seller reviews the potential buyer's property criteria to determine if the property is appropriate for the buyer. The seller and the buyer communicate directly over the duration of the real estate transaction. This open communication negates the need to use a real estate agent. The system provides directions that enable the seller and buyer to perform a smooth, efficient transaction.

One objective of the present invention is to enable interaction between a property buyer or seller; or landlord and renter to facilitate transaction for a property, without requiring a real estate agent or broker.

It is another objective of the invention to provide ready access to listings of real estate, businesses, or other property being offered for sale.

Yet another objective is to eliminate the real estate agent fee from a real estate transaction.

Yet another objective is to provide a system and a method for matching buyers and sellers through a remote terminal, wherein the system and method include: readily available online access to a database containing several property listings; online search capabilities permitting a prospective buyer to select a group of properties based on a set of criteria; listings of properties according to a seller and property identification; qualification of buyer based on information supplied by the buyer; and a means of transmitting information about an interested buyer to a seller.

Yet another objective is to provide a network that connects a buyer and seller in real time.

Yet another objective is to enhance the veracity of the transaction by providing property court records and personal information about the buyer and seller.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram view of an exemplary system for direct matching of a buyer and a seller for a real estate transaction without requiring a real estate agent, in accordance with an embodiment of the present invention;

FIG. 2 illustrates a screen shot of an exemplary property listing visible on a network, in accordance with an embodiment of the present invention;

FIG. 3 illustrates a screen shot of an exemplary communication module on the network that enables a buyer and a seller to communicate, in accordance with an embodiment of the present invention; and

FIGS. 4A and 4B illustrate flowchart diagrams of an exemplary method for direct matching of a buyer and a seller for a real estate transaction without requiring a real estate agent, in accordance with an embodiment of the present invention.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments.

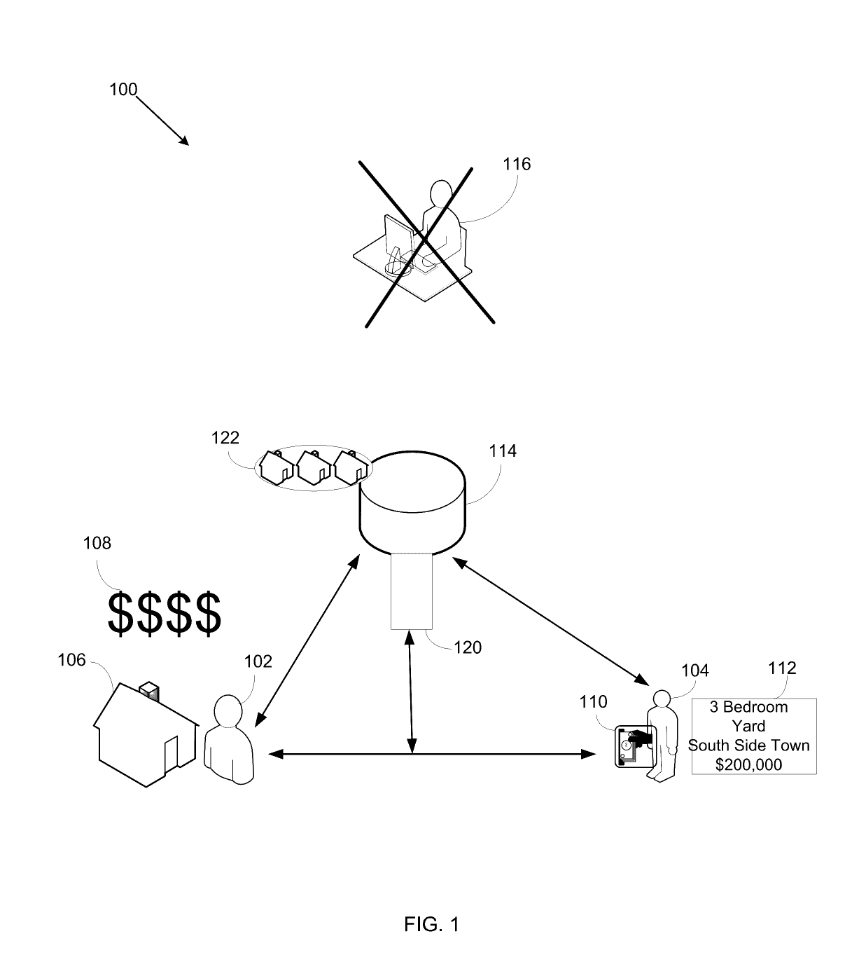

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

A network enabled system and method for transacting property sales and rentals without a real estate agent is referenced in FIGS. 1-4B.

In one embodiment of the present invention, shown in FIG. 1, a system 100 provides a network 114, which is accessible to a property seller 102, a potential buyer 104, a landlord, and a potential renter. The network 114 is configured to facilitate a real estate transaction for at least one property 106 between the buyer 104 and the seller 102; or in alternative embodiments, between the landlord and renter.

The network 114 creates an environment that facilitates the transaction between seller 102, buyer 104, landlord, and renter of property to enter into a contract and transfer property safely without relying on or paying commission to a real estate agent or broker. The network is operational, such that the buyer and seller may communicate in real time, and thereby save time and resources. Additionally, the seller 102 and buyer 104 not only display the property for sale and the desired property criteria, but also provide property records and personal information from the seller 102 and buyer 104 to increase the veracity of the transaction.

It is central to the theme of the present invention that the system 100 and method 200 is operable without a real estate agent or broker. The system 100 enables direct communication between seller 102 and buyer 104 on a network. The system and method also enables enabling facilitated listing and viewing of the property listing 118, which allows access to seller and buyer personal information and property records, and directions for performing the transaction coordination functions.

In this manner, the system 100 and method 200 substantially negates the need for a real estate agent 116 or broker to conduct the transaction, as the seller 102 and buyer 104 have real time access to property information, personal information about the other property, and property records. In one alternative embodiment, the system 100 and method 200 may also be used between a landlord who has a rental property to rent, and a potential renter. This rental model works substantially the same as the sales model, except that a rental or lease agreement is transacted between buyer and seller.

In some embodiments, the system 100 may be configured to match a seller 102 of a real estate property 106 with a potential buyer 104 through a network 114. The network 114 may include an internet platform that is accessible by an administrator, the buyer 104, and the seller 102. The network 114 comprises a communication module 120 that enables a seller 102 and a buyer 104 to communicate in real time. The network 114 further comprises a data storage module 122 configured to store information about the property 106. The network 114 may include, without limitation, a social network, a business network, a real estate network, and a website.

In some embodiments, the buyer 104 and seller 102 may pay a fee to access the network 114. A login name and a password may be required to access the network 114. Though permissions may be given by the administrator. The network 114 may also be integrated with a social network 114, such as Facebook™, Twitter™, and a Multiple Listing Service (MLS). In some embodiments, the property is listed on both the network 114 (exclusive listing), and other social networks known in the art (non-exclusive listing).

In some embodiments, the system 100 may provide the seller 102 with numerous technological tools for displaying the property 106 in an attractive, accurate manner. The system 100 also provides technological tools for the buyer 104 to indicate at least one property criteria 112 for a desired property. The property criteria 112 is accessible by the seller on the network 114. The seller 102 may review the potential buyer's 104 property criteria 112 to determine if the property 106 is appropriate for the buyer 104. The system 100 enables the seller 102 and the buyer 104 to communicate directly over the duration of the real estate transaction through a communication module 120, such as a chat room. This open communication between buyer 104 and seller 102 further negates the need to use a real estate agent 116. The system 100 provides directions that enable the seller 102 and the buyer 104 to perform a smooth, efficient transaction; and thereby not require the services of a real estate agent 116.

In one alternative embodiment, the system 100 and method 200 may be used in the rental market; whereby a landlord and a renter are matched through the network 114. Here, the fundamental steps are substantially the same, except that the landlord lists a rental property along with a rental listing price. The potential renter likewise, lists a rental property criteria on the network. The landlord may then select and directly communicate with potential renters for consummating the real estate transaction. It is significant to note that the rental real estate transaction may be simpler, since many of the additional transactional functions for purchasing a property 106 are not necessary, i.e., lien verification, escrow, termite inspection, home owners insurance, loan approval, and the like.

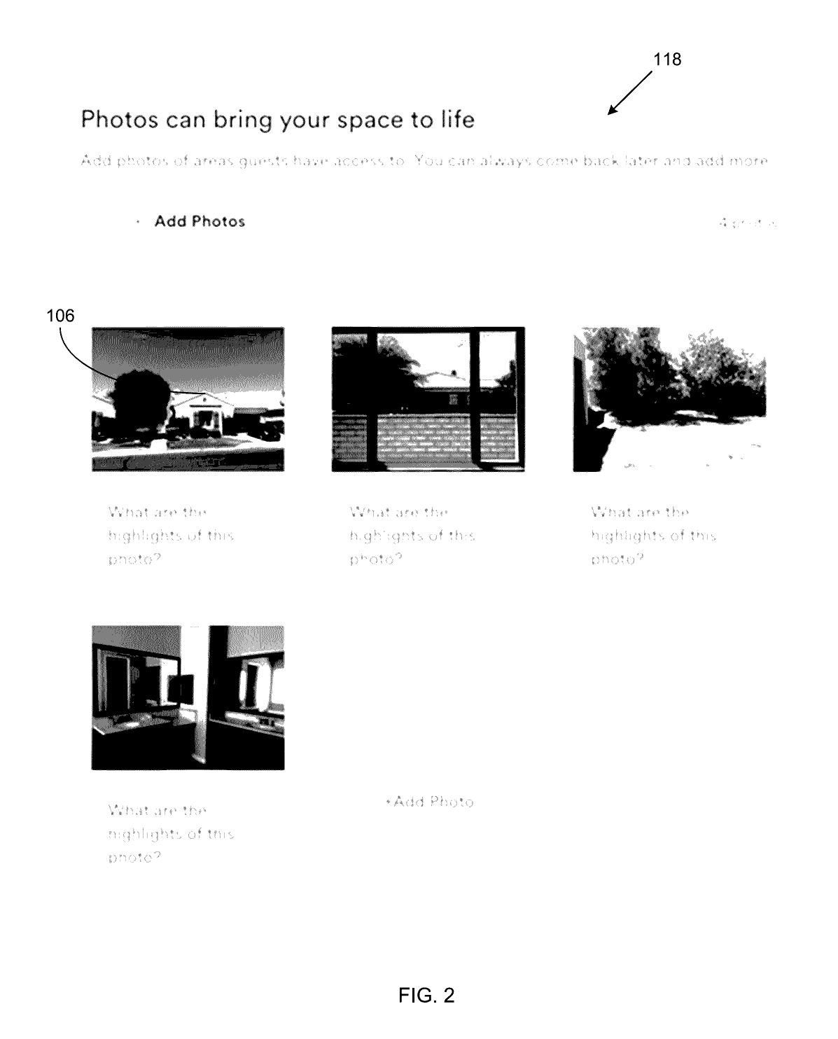

As referenced in FIG. 2, the seller 102 lists at least one property 106 for sale as a property listing 118. Once listed, the property 106 displays on the network 114. The property 106 may include, without limitation, a home, a commercial property 106, a plot of land, an apartment, a business, and a time share. The seller 102 also provides general information about the property 106, such as address, year of construction, size, number of bedrooms and bathrooms, whether it is a corner lot, and general neighborhood and schooling information.

In one embodiments, the seller 102 may enhance the property listing 118 by providing: photographs of the property 106, 3-dimensional walk through videos and floorplans of the property 106, and neighborhood and schooling statistics. In its most simple format, the seller's property listing 118 may include a statement visible on the network 114 that states: “I am a Seller 102 looking for (SFR/Condo/Townhouse/MFR/Other) within (X miles) from (Zip Code/City).”. Though in other embodiments, the seller may also utilize more creative means for marketing the property 106.

Once the seller 102 has listed the property 106, the seller 102 may then determine a listing price 108 for the property 106. The listing price 108 may be determined on numerous criteria 112, including, without limitation, comparable listing prices in the neighborhood, appraiser estimates, and previously sold properties of similar nature. The seller may change the listing price 108 at any time throughout the real estate transaction.

At this point, the system 100 requires that the seller 102 provide a personal seller 102 information and at least one property record to verify ownership of the property 106. Those skilled in the art will recognize that real estate fraud can be a problem, and may be especially problematic when a real estate agent 116 is not involved to verify the numerous requirements and procedures for a real estate transaction. In one exemplary verification, the name of the seller 102 must match the title of the property 106. The property records also provide greater information about the history and state of the property 106. The property records are effective for indicating liens, termite damage, and number of owners.

Specifically, the seller 102 provide the system 100 with personal information and real estate property records corresponding to the property 106 to be sold. The records can then be search by a remote data terminal associated with a potential buyer 104. The results of this search are then provided to the potential buyer 104, who indicates specific property listing 118 that the potential buyer 104 may be interested in purchasing.

After the personal buyer 104 information and the at least one property record have been verified by the system 100, the seller 102 may open the property 106 for visits. The visits may include an open house, including a free, one-day event held by the seller 102 to show a listed residential property 106 to any interested buyer. It is significant to note that the real estate agent 116 generally holds open houses, but in the present system 100, the seller 102 performs all of the duties of an open house. In other embodiments, the showing utilizes a lock box with an entry code. The seller 102 gives the entry code to potential buyer 104s for viewing the property 106 without requiring the seller 102 to be present.

In some embodiments, the system 100 may enable the buyer 104 to perform correlating steps to review and potentially purchase the property 106 from the seller 102. The system 100 allows the buyer 104 to, in essence, advertise the need to buy a specific property 106. Initially, the buyer 104 logs into the network 114. As discussed above, the log in may include providing personal information and passwords.

Once logged into the network 114, the buyer 104 may generate at least one property criteria 112 for a desired property 106. The at least one property criteria 112 forms a “wish list” of the buyer 104. The property criteria 112 is especially useful since it allows the seller 102 to view multiple property criteria from multiple buyers simultaneously. The seller 102 then has a better idea of appropriate matches for the property 106.

In some embodiments, the property criteria 112 may include, without limitation, property location, property size, number of bedrooms and bathrooms, price range, architectural style, corner lot, school ratings, availability of a yard, and parking facilities. Those skilled in the art, in light of the present teachings, will recognize that the buyer 104 most often requires a bank loan to purchase the property 106. Thus, another criteria 112 the buyer 104 must be aware of is the buyer's credit rating, so as to select a property 106 within an appropriate price range.

After forming the property criteria 112, the buyer 104 enters the property criteria 112 for display on the network 114. The buyer 104 may also list the property criteria 112 on other social networks, such as Facebook™, Twitter™, and Links™. In its most simple format, the buyer's property criteria listing may include a statement visible on the network 114 that states: “I am a Buyer looking for (SFR/Condo/Townhouse/MFR/Other) within (X miles) from (Zip Code/City).”

Similar to the seller 102, the buyer 104 provides personal buyer information. The personal buyer information may include name, prior property purchases, income, family members, and the like. The personal buyer information is input into the system 100 for viewing by the seller 102. The seller 102 may then verify the buyer personal information before proceeding with the real estate transaction. The system 100 provides multiple provisions are made to verify that the sellers 102 who list property 106, the property 106, and the potential buyers 104 are accurately represented in the network 114. Further, the system 100 facilitates transaction coordination functions between the buyer 104 and seller 102 in the areas of escrow, property inspection, loan appraisals, insurance, and the like.

After the identifications are verified, the buyer 104 visits the listed property 106, generally during the open house. The visit may occur during a predetermined open house, where other potential buyers are in attendance. During the visit, the buyer 104 may verify which of the property criteria 112 are satisfied. Finally, the buyer 104 makes an offer 110 for the listed property 106. The offer 110 may be higher or lower than the list price provided by the seller 102.

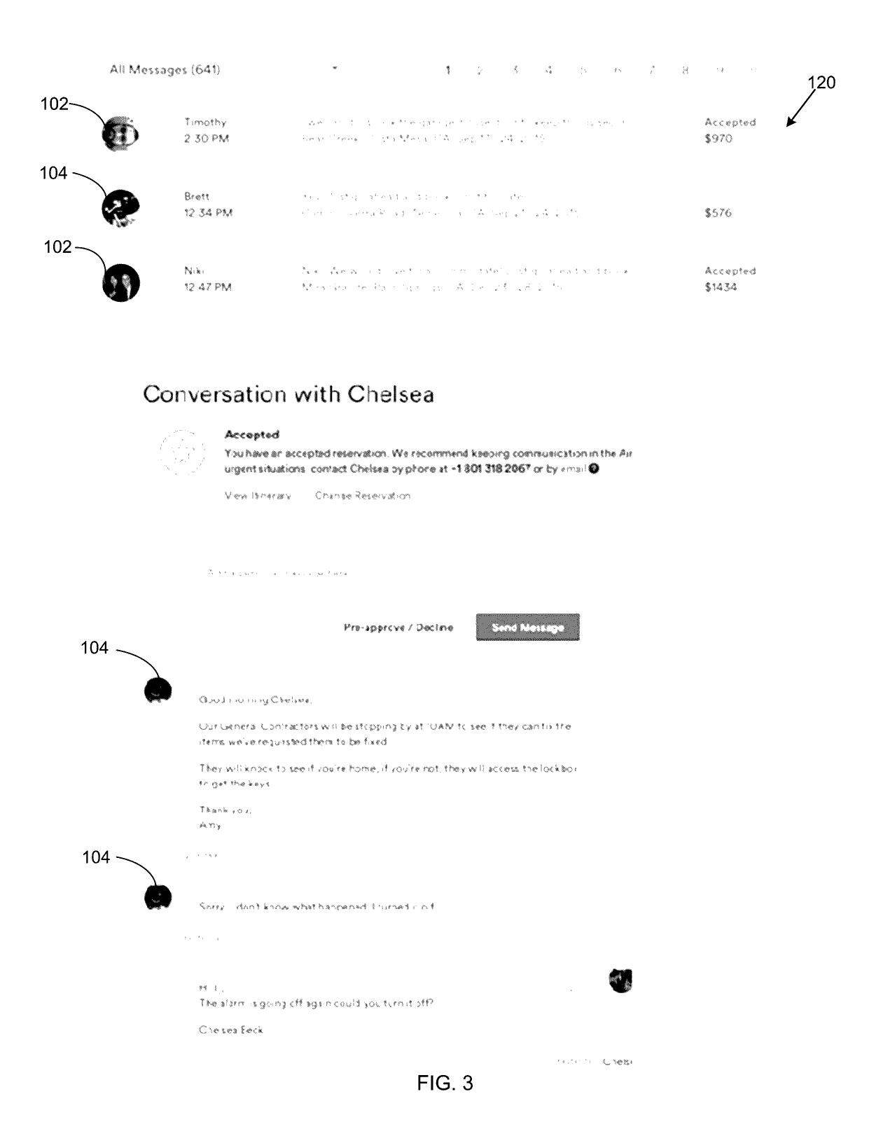

As illustrated in FIG. 3, the network 114 is configured to enable the buyer 104 and seller 102 to remain in constant communication through a communication module 120. The communication module 120 provides a platform that enables easy access between seller 102 and buyer 104. This open communication facilitates coordination of the transaction and also allows each party to clarify questions, misunderstanding, and the like. It is this communication that streamlines the process so that the real estate agent 116 is not required. In one possible embodiment, the communication module 120 is a chat page that connects the buyer 104 and seller 102 instantaneously through their computers, mobile phone devices, and televisions. Though in other embodiments, communication may be possible through email, phone, text, or letters. The constant communication enables the buyer 104 to inquire more about the property 106 and the selling conditions thereof.

After viewing the property 106, the buyer 104 may present to the seller 102 an offer 110 for purchase of the property 106. The offer 110 does not necessarily have to match the listing price 108. After the buyer 104 makes an offer 110 that is accepted by the seller 102, the buyer 104 and seller 102 perform at least one transaction coordination function. The transaction coordination function is necessary to transact the real estate purchase. The transaction coordination function may involve legal, financing, inspection, and insurance procedures known in the art to consummate the transaction.

Other examples of transaction coordination functions may include: depositing money in an escrow, termite inspection, fungal and asbestos inspection, loan qualification, property 106 inspection, homeowner insurance, liability insurance, hazard insurance. Further, a property 106 manager may be determined by one or both parties.

In one exemplary transaction coordination function, the seller 102 pays for the title transfer, and the buyer 104 pays for the escrow fee. Though this arrangement may be negotiated between the parties. The system 100 may also require the seller 102 to perform the following transaction coordination functions: obtain the preliminary title report, obtain the NHD report, and obtain termite clearance and certification. The system 100 may also require the buyer 104 to perform the following transaction coordination functions: obtain an appraisal, obtain a loan approval, and obtain the appropriate insurance.

The system 100 is especially effective because the transaction coordination functions are generally technical and beyond the scope of the ordinary property seller 102 and potential buyer 104. The system 100 provides step-by-step directions for performing the transaction coordination function. In situations where the seller 102 and buyer 104 cannot perform a specific transaction coordination function, the system 100 may also direct the buyer 104 and seller 102 towards a service agent that can help with the at least one transaction coordination function. In either case, the transaction is consummated without real estate agent fees or substantial transaction coordination fees.

In one alternative embodiment, the system 100 generates revenue by allowing the seller 102 to utilize other avenues for selling the property 106, in conjunction with the network 114. For example, the seller 102 is given a non-exclusive right to list the property 106. In the non-exclusive rights embodiment, the system 100 maintains the property 106 on the network 114 while a traditional real estate agent 116 simultaneously lists the property 106 on MLS.

In some embodiments, the system 100 provides a link to the MLS listing, such that the property 106 is listed on both the network 114 of the system 100, and the MLS. The system 100 may charge a nonexclusive listing fee, such as 1.5% for allowing the seller 102 to utilize additional avenues in conjunction with the network 114. However, the seller 102 is not required to pay the listing fee if the seller 102 finds a buyer 104 through the network 114.

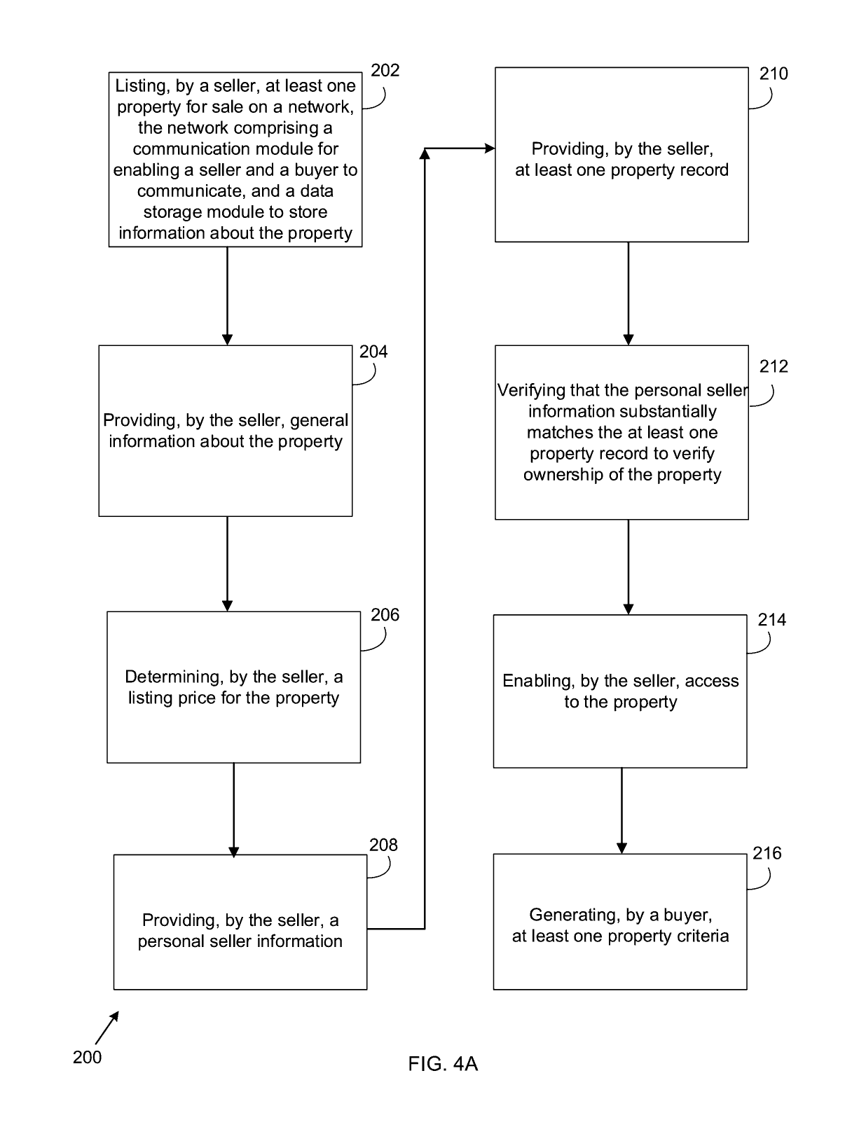

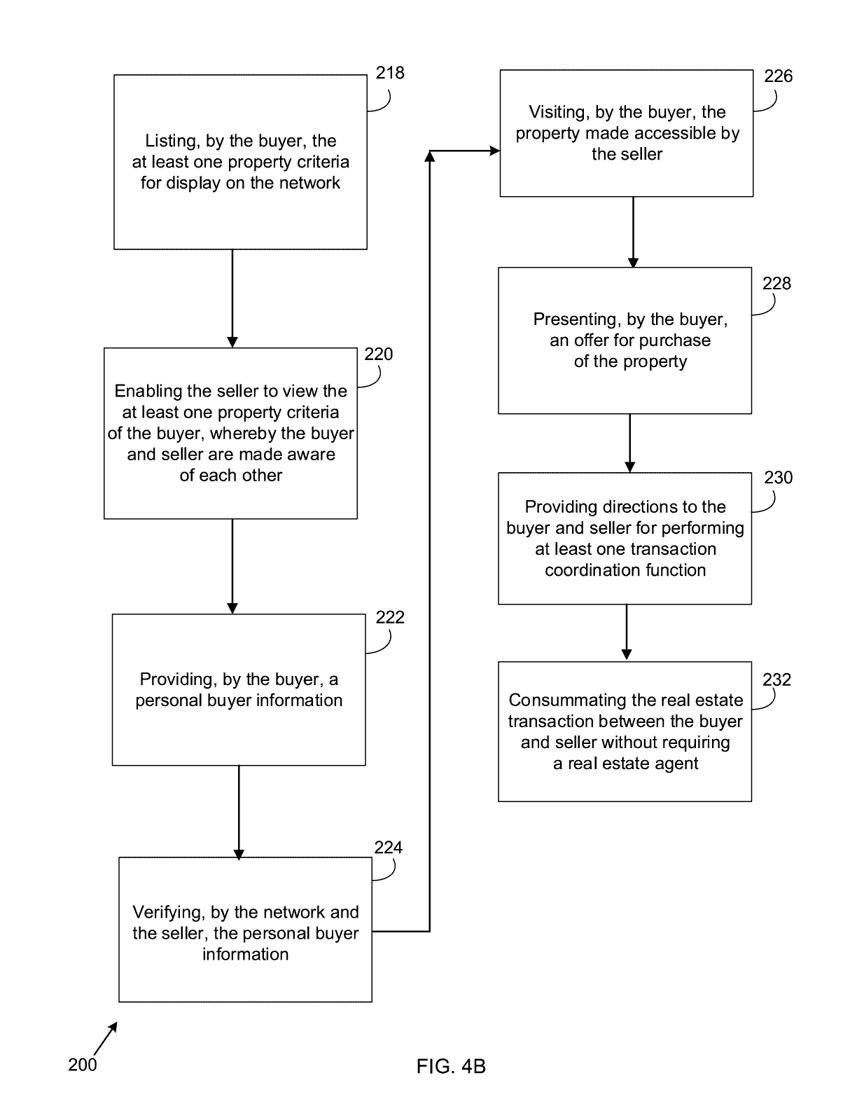

FIGS. 4A and 4B illustrate a flowchart diagram of an exemplary method 200 for direct matching of a buyer 104 and a seller 102 for a real estate transaction without requiring a real estate agent 116. The method 200 provides a network 114, which is accessible to a property seller 102 and a potential buyer 104 that facilitates the procedures for a direct real estate transaction between the buyer 104 and the seller 102, such that a real estate agent 116 is not required. The method 200 also allows the buyer 104 to create a “wish list”, and the seller 102 to list multiple properties. The method 200 also provides directions for performing at least one transaction coordination function, which are required to consummate the transaction. The method 200 provides directions and facilitates communication between seller 103 and buyer 104, such that a real estate agent 116 is not required to consummate the real estate transaction.

The method 200 may include an initial Step 202 of listing, by a seller 102, at least one property 106 for sale on a network 114, the network 114 comprising a communication module 120 for enabling the seller 102 and a buyer 104 to communicate in real time, the network 114 further comprising a data storage module 122 configured to store information about at least one property 106.

The method 200 may further comprise a Step 204 of providing, by the seller 102, general information about the property 106. A Step 206 includes determining, by the seller 102, a listing price 108 for the property 106. The seller 102 lists at least one property 106 for sale as a property listing 118. Once listed, the property 106 displays on the network 114. The seller 102 also provides general information about the property 106, such as address, year of construction, size, number of bedrooms and bathrooms, whether it is a corner lot, and general neighborhood and schooling information.

In some embodiments, a Step 208 comprises providing, by the seller 102, a personal seller 102 information. The system 100 requires that the seller 102 provide a personal seller 102 information and at least one property record to verify ownership of the property 106. A Step 210 includes providing, by the seller 102, at least one property record. A Step 212 comprises verifying that the personal seller 102 information substantially matches the at least one property record to verify ownership of the property 106.

In some embodiments, a Step 214 may include enabling, by the seller 102, access to the property 106. After the personal buyer 104 information and the at least one property record have been verified by the system 100, the seller 102 may open the property 106 for visits. The visits may include an open house, including a free, one-day event held by the seller 102 to show a listed residential property 106 to any interested buyer.

A Step 216 comprises generating, by a buyer 104, at least one property criteria 112. The property criteria 112 may include, without limitation, property location, property size, number of bedrooms and bathrooms, price range, architectural style, corner lot, school ratings, availability of a yard, and parking facilities. A Step 218 includes listing, by the buyer 104, the at least one property criteria 112 for display on the network 114. After forming the property criteria 112, the buyer 104 enters the property criteria 112 for display on the network 114. The buyer 104 may also list the property criteria 112 on other social networks, such as Facebook™, Twitter™, and Links™.

A Step 220 comprises enabling the seller 102 to view the at least one property criteria 112 of the buyer 104, whereby the buyer 104 and seller 102 are made aware of each other. Similar to the seller 102, the buyer 104 provides personal buyer information. The personal buyer information may include name, prior property purchases, income, family members, and the like. The personal buyer information is input into the system 100 for viewing by the seller 102. The seller 102 may then verify the buyer personal information before proceeding with the real estate transaction. A Step 222 may include providing, by the buyer 104, a personal buyer 104 information.

The method 200 further includes a Step 224 of verifying, by the network 114 and the seller 102, the personal buyer 104 information. The system 100 provides multiple provisions are made to verify that the sellers 102 who list property 106, the property 106, and the potential buyers 104 are accurately represented in the network 114. Further, the system 100 facilitates transaction coordination functions between the buyer 104 and seller 102 in the areas of escrow, property inspection, loan appraisals, insurance, and the like.

A Step 226 comprises visiting, by the buyer 104, the property 106 made accessible by the seller 102. After the identifications are verified, the buyer 104 visits the listed property 106, generally during the open house. The visit may occur during a predetermined open house, where other potential buyers are in attendance. During the visit, the buyer 104 may verify which of the property criteria 112 are satisfied.

The method 200 may further include a Step 228 of presenting, by the buyer 104, an offer 110 for purchase of the property 106. The buyer 104 makes an offer 110 for the listed property 106. The offer 110 may be higher or lower than the list price provided by the seller 102. A Step 230 further comprises providing directions to the buyer 104 and seller 102 for performing at least one transaction coordination function. The directions may include technical information about inspections, loan qualifications, and insurance requirements. In some embodiments, the transaction coordination function may require communication between the seller 102 and the buyer 104 through the communication module 120.

A final Step 232 may include consummating the real estate transaction without requiring a real estate agent 116. By enabling direct communication between seller 102 and buyer 104; enabling easy viewing of the property listing 118, enabling access to seller and buyer personal information and property records, and providing directions for performing the transaction coordination functions, the method 200 substantially negates the need for a real estate agent 116.

In one alternative embodiment, the method 200 may be operable for transacting a rental agreement; whereby the method 200 includes an additional step of transacting a rental agreement for at least one property between a landlord and a renter, whereby the landlord operates substantially the same as the seller, and the renter operates substantially the same as the buyer. In this rental embodiment, the property is a rental property.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A non-transitory program storage device readable by a machine tangibly embodying a program of instructions executable by the machine to perform a method for transacting property sales and rentals without a real estate agent, the the method comprising:
listing, by a seller, at least one property for sale on a network, the network comprising a communication module for enabling the seller and a buyer to communicate in real time, the network further comprising a data storage module configured to store information about at least one property;
providing, by the seller, general information about the at least one property;
determining, by the seller, a listing price for the at least one property;
providing, by the seller, a personal seller information;
providing, by the seller, at least one property record;
verifying that the personal seller information substantially matches the at least one property record to verify ownership of the property;
enabling, by the seller, access to the at least one property;
generating, by the buyer, at least one property criteria;
listing, by the buyer, the at least one property criteria for display on the network;
enabling the seller to view the at least one property criteria of the buyer, whereby the buyer and seller are made aware of each other;
providing, by the buyer, a personal buyer information;
verifying, by the network and the seller, the personal buyer information;
visiting, by the buyer, the property made accessible by the seller;
presenting, by the buyer, an offer for purchase of the at least one property;
providing directions to the buyer and seller for performing at least one transaction coordination function, the at least one transaction coordination function operable to require communication between the seller and the buyer through the communication module; and
consummating the real estate transaction directly between the seller and the buyer.

2. The method of claim 1, further including a step of generating revenue by charging a fee to the seller, the buyer, or both, to access the network.

3. The method of claim 1, wherein the step of listing at least one property by the seller further comprises listing the at least one property on a property listing.

4. The method of claim 1, wherein the communication portal is configured to provide a platform for the buyer and the seller to communicate through the duration of the real estate transaction.

5. The method of claim 1, wherein the at least one property includes at least one of the following: a single family home, a condo, a duplex, a time share, a commercial property, and a farm.

6. The method of claim 1, wherein the at least one property criteria includes at least one of the following: property location, property size, number of bedrooms and bathrooms, price range, architectural style, corner lot, school ratings, availability of a yard, parking facilities, and zoning restrictions.

7. The method of claim 1, wherein the network is a social network, a business network, a real estate network, and a website.

8. The method of claim 1, wherein the at least one coordination function includes at least one of the following: depositing money in an escrow, termite inspection, fungal and asbestos inspection, loan qualification, property inspection, homeowner insurance, liability insurance, hazard insurance.

9. The method of claim 1, wherein the at least one property record includes at least one of the following: title, lien, maintenance records, and prior damage.

10. The method of claim 1, wherein the method further comprises a step of transacting a rental agreement for at least one property between a landlord and a renter, whereby the landlord operates substantially the same as the seller, and the renter operates substantially the same as the buyer.

11. The method of claim 10, wherein the at least one property is a rental property.

12. A non-transitory program storage device readable by a machine tangibly embodying a program of instructions executable by the machine to perform a method for transacting property rentals without a real estate agent, the method comprising:
listing, by a landlord, at least one property for rent on a network, the network comprising a communication module for enabling the landlord and a renter to communicate in real time, the network further comprising a data storage module configured to store information about at least one property;
providing, by the landlord, general information about the at least one property;
determining, by the landlord, a rental listing price for the at least one property;
providing, by the landlord, a personal landlord information;
providing, by the landlord, at least one property record;
verifying that the personal landlord information substantially matches the at least one property record to verify ownership of the property;
enabling, by the landlord, access to the at least one property;
generating, by the renter, at least one property criteria;
listing, by the renter, the at least one property criteria for display on the network;
enabling the landlord to view the at least one property criteria of the renter, whereby the renter and landlord are made aware of each other;
providing, by the renter, a personal renter information;
verifying, by the network and the landlord, the personal renter information;
visiting, by the renter, the property made accessible by the landlord;
presenting, by the renter, an offer for rental of the at least one property;
providing directions to the landlord and renter for performing at least one transaction coordination function, the at least one transaction coordination function operable to require communication between the landlord and the renter through the communication module; and
consummating the rental real estate transaction without requiring a real estate agent.

13. The method of claim 12, further including a step of generating revenue by charging a fee to the landlord, the renter, or both, to access the network.

14. The method of claim 12, wherein the step of listing at least one property by the landlord further comprises listing the at least one property on a property listing.

15. The method of claim 12, wherein the communication portal is configured to provide a platform for the landlord and the renter to communicate through the duration of the real estate transaction.

16. The method of claim 12, wherein the at least one property includes at least one of the following: a single family home, a condo, a duplex, a time share, a commercial property, and a farm.

17. The method of claim 12, wherein the at least one property criteria includes at least one of the following: property location, property size, number of bedrooms and bathrooms, price range, architectural style, corner lot, school ratings, availability of a yard, parking facilities, and zoning restrictions.

18. The method of claim 12, wherein the network is a social network, a business network, a real estate network, and a website.

19. A network enabled system for transacting property sales and rentals without a real estate agent, the system comprising:
a network, the network configured to facilitate a real estate transaction without use of a real estate agent;
a data storage portion, the data storage portion configured to store information about at least one property, the information about the at least one property accessible on the network;
a seller or a landlord, the seller or the landlord operable to list the information about the at least one property on the data storage portion, the seller or the landlord further operable to generate a list price for the at least one property;
a buyer or a renter, the buyer or the renter operable to list at least one property criteria on the data storage portion, the buyer or the renter further operable to view the information about the at least one property and the list price on the network, the buyer or the renter further operable to provide an offer for the at least one property, whereby the seller or the landlord views the at least one property criteria on the network, whereby the seller or the landlord has the option of accepting or rejecting the offer;
at least one transaction coordination function, the at least one transaction coordination function configured to enable the real estate transaction for the at least one property to proceed, whereby the seller or the landlord, and the buyer or the renter perform the at least one transaction coordination function; and
a communication module, the communication module configured to enable the seller or the landlord and the buyer or the renter to communicate regarding the at least one transaction coordination function and the real estate transaction for the at least one property.

20. The method of claim 19, wherein the network is a social network, a business network, a real estate network, and a website.
